(19) United States
(12) Patent Application Publication
(10) Pub. No.: US 2015/0143920 A1
(43) Pub. Date: May 28, 2015

(54) METHOD OF ASSESSING AND CONDITION MONITORING OF FLUID CONDUITS AND APPARATUS THEREFOR

(71) Applicant: PARADIGM FLOW SERVICES LIMITED, Aberdeenshire (GB)

(72) Inventor: Hugh Mackenzie, Aberdeenshire (GB)

(21) Appl. No.: 13/261,889

(22) PCT Filed: Nov. 14, 2012
(86) PCT No.: PCT/GB2012/052827

§ 371 Date: May 14, 2014

(30) Foreign Application Priority Data
Nov. 14, 2011 (GB) 1119635.9
May 14, 2012 (GB) 1208415.8

(51) Int. Cl. G01F 1/34

(52) U.S. Cl. CPC G01F 1/34
USPC 73/861.52; 73/861.42

(57) ABSTRACT

A method of and apparatus for assessing the condition of a fluid conduit. The method comprises providing a measurement apparatus comprising a measurement region in fluid communication with the fluid conduit. The measurement apparatus is operable to measure at least one of pressure and flowrate in the measurement region. A pressure surge is effected or generated to propagate in the fluid conduit, and at least one of a pressure response or a flowrate response from the fluid conduit is measured. From a pressure data set and a flowrate data set, a data set representative of the cross sectional area along the fluid conduit is determined. This enables average or over all area profiles along long fluid pipelines to be deduced.

The present invention relates to the field of the assessment and condition monitoring of fluid conduits. In particular, aspects of the invention are methods and apparatus which use pressure surges for assessment and monitoring of the internal condition of fluid conduits, including the build-up and deposition of scale, sand, waxes and other materials on the interior surface of conduits. The invention has particular application to pipelines and other conduits in the oil and gas exploration, production and transportation industry.

### BACKGROUND TO THE INVENTION

It is known to use pressure surges for investigating conditions along pipelines. Well known examples in the water industry include the detection and location of leaks (e.g. Taghvaei et al, 2008 [Ref #8], Duan, et al, 2011 [Ref #2]), blockages and restrictions (e.g. Arbon, et al, 2008 [Ref #1], Lee et al, 2008 [Ref #6]). In addition, inverse transient methods have been developed for assessing characteristics of pipeline networks (e.g. Kapelan et al, 2003 [Ref #5], Shamlooa & Haghighi, 2009 [Ref #7]). All of these techniques have enjoyed some success in practical applications.

In the oil industry, surges are sometimes used to determine flowrates or to infer pressure distributions along a line. For example, if there is a valve at the end of a pipe and the area of the pipe is uniform (at least in the region close to the valve), by closing the valve rapidly the resulting pressure rise will satisfy the Joukowski relationship and so can be regarded as a measure of the velocity of the fluid before closure. Assuming that the cross-sectional area of the pipe is known, it is therefore possible to measure flowrates with good accuracy. Although practical issues limit the acceptability of the method, it can be accurate and it requires no special equipment except a pressure sensor. One example is described in international patent publication number WO 96/15427 [Ref #3], in which the estimation of flowrates through the measurement of Joukowski pressures following intentional valve closure is described.

In addition, the subsequent pressure history at the valve could be used to infer the steady-flow pressure gradient along the pipe and hence to assess the flow resistance characteristics, as described in international patent publication number WO 02/25062 [Ref #4]. For a known pipe area, this would be a measure of the surface roughness condition.

However, the methods of WO 96/15427 and WO 02/25062 rely on the rapid closure of a pipeline valve to cause a change in the flowrate from an initial flowing condition to a zero flow condition. The initial flow conditions are inherently noisy, and therefore the collected data has a high level of background noise. The methods of WO 96/15427 and WO 02/25062 also rely on high flowrates, which exacerbate the ambient noise levels. The closure of the valve (which is a valve forming a part of the pipeline system) generates additional noise, and therefore the pressure measurement signal has a poor signal to noise ratio, limiting its usefulness in pipeline assessment applications. Furthermore, the process of closing the valve is difficult to perform quickly, and therefore the resulting pressure surge is generated slowly. This limits the use of the resulting pressure transient for the detection of non-uniformities or gradual changes in the pipeline condition.

In some offshore applications, the operator wishes to know how the diameter/area of a pipe varies along its length. In some cases, this can be achieved by direct geometrical measurement or by the use of an intelligent pig, but these methods are not always suitable, particularly where there is a risk of the pig becoming stuck at a restriction or blockage in the pipeline.

It is amongst the aims and objects of the invention to provide a method of and apparatus for assessing and/or condition monitoring of pipelines which avoid the drawbacks and disadvantages of the prior art.

It is an aim of at least one aspect of the invention to provide a method of using pressure surges to infer area profiles of fluid conduits and a corresponding apparatus.

Other aims and objects will become apparent from reading the following description.

### SUMMARY OF THE INVENTION

According to first aspect of the invention, there is provided a method of assessing the condition of a fluid conduit, the method comprising:

providing a measurement apparatus comprising a measurement region in fluid communication with the fluid conduit, the measurement apparatus operable to measure pressure and flowrate in the measurement region;
effecting or generating a pressure surge to propagate in the fluid conduit;
measuring a pressure response from the fluid conduit to provide a pressure data set;
measuring a flowrate response from the fluid conduit to provide a flowrate data set;
determining, from the pressure data set and the flowrate data set, a condition data set representative of the cross-sectional area along the fluid conduit.

In the context of the description, the term “the condition of a fluid conduit” is used to generally to refer to the overall state of the flow path defined by a fluid conduit (primarily the effective flow area of the conduit), including its internal condition which may be affected for example by build-up and deposition of scale, sand, waxes and other materials on the interior surface. The term should not be construed as relating exclusively to the inherent physical condition of the conduit or its components (although in some cases there may be a link between the overall condition of the conduit and its inherent physical condition).

The term “pressure surge” is used for convenience and will be understood to refer to a change in pressure conditions in the fluid conduit. Such a change in conditions will of course also change fluid velocity and flowrate. References to pressure surge do not necessarily imply generation of a surge by means of a controlled pressure change; a controlled flowrate change could also effect a “pressure surge”, and indeed the terms “velocity surge” or “flowrate surge” could be used to describe the same effect.

In the present invention, the area is inherently unknown and is inferred from the pressure data set and the flowrate data set. Preferably, the cross-sectional area is determined using the equation:

Q=Q₀±A·(P−P₀)/ρc

where Q and Q₀ are flowrates; A is the cross-sectional area of the fluid conduit; P and P₀ are pressures; ρ is fluid density; and c is the speed of sound in the fluid.

The measurement region may be a fluid conduit portion of the measurement apparatus, which may be continuous with the fluid conduit of which the condition is to be assessed.

Preferably, the method comprises determining data representative of the cross-sectional area at one or more locations along the fluid conduit. The method may comprise determining data representative of average cross-sectional area of the fluid conduit in a region or section of the fluid conduit.

In preferred embodiments of the invention, one of the pressure or flowrate in the measurement region is controlled, at least during a measurement interval, to render it approximately constant before the pressure surge is effected or generated, and approximately constant after the pressure surge is effected or generated. Preferably, the one of the pressure or flowrate is held substantially constant before and after the pressure surge is generated. By maintaining one of the pressure or flowrate in the measurement region approximately or substantially constant, measurement inaccuracies in the method may be reduced. However, in methods according to alternative embodiments of the invention, slowly varying pressure or flowrate (i.e. variations to pressure or flowrate which are significantly slower than an intentional step-like change) conditions may be used with the contemplated measurement and analysis steps and without a significant effect on the results obtained.

Preferably the method comprises opening a valve to generate a pressure surge in the fluid conduit. Preferably the valve forms a part of the measurement apparatus, and is selected or designed for rapid actuation with low noise generation. This is in contrast to prior art approaches to the application of pressure surges in pipeline systems which use valves that form a part of the pipeline system and which are not designed for rapid or low noise actuation. These pipeline valves are therefore not capable of generating steep fronted pressure surges. The rapid opening of the valve provides improved differentiation between friction and area variations and also enables the cross-sectional area versus distance along the fluid conduit to be analysed in greater detail. This is important for the assessment of gradual changes in cross-sectional area, as may result from the build-up and deposition of scale, sand, waxes and other materials on the interior surface of a pipeline.

The method may comprise causing a flow condition in the measurement region to change from a first flow condition in which there is negligible flow of fluid in the measurement region to a second flow condition in which fluid flows in the measurement region and the fluid conduit, to thereby effect or generate a pressure surge to propagate in the fluid conduit. The method may therefore comprise creating a flow of fluid in the fluid conduit. Preferably the flowrate in the fluid conduit prior to the generation of a pressure surge in the fluid conduit is negligible, and more preferably is zero. Thus the initial flow conditions may provide a relatively low level of background noise, and the collected data may have a good signal to noise ratio. This is a significant advantage over prior art approaches to the use of pressure surges in pipeline applications which use an initial flow condition with a correspondingly high level of background noise. This approach also reduces the influence of friction on the measurements.

Preferably, the method comprises:

effecting or generating a pressure surge in the fluid conduit at a first upstream location or region;
measuring the pressure response from the fluid conduit;
measuring the flowrate response from the fluid conduit;
determining, from a pressure data set and a flowrate data set, a data set representative of the cross-sectional area along the fluid conduit downstream from the first upstream location or region.

Preferably, the pressure response and/or flowrate response are sampled over a measurement interval. This may begin a short time after the step of effecting or generating a pressure surge where the amplitude of the pressure surge is known, but preferably begins before the step of effecting or generating a pressure surge. This has the benefit of identifying the amplitude and character of the pressure surge. The pressure surge is caused to propagate in the fluid conduit. Preferably, the measurement interval finishes before the pressure surge reaches a blockage or complete restriction (such as a fluid conduit termination or a valve) in the fluid conduit.

Preferably, the method comprises sampling the flowrate with high accuracy at a rate greater than 100 Hz, and preferably greater than 1 kHz. The interpretation of the measured data is preferably based in the time domain.

Preferably the fluid conduit is a pipeline flooded with a liquid. Preferably, the method comprises the step of flooding the fluid conduit with a liquid. The method may be performed on a pressurised fluid conduit, and the method may comprise pressurising the fluid conduit to a predetermined pressure. The predetermined pressure may be selected to be sufficient to reduce a volume of gas in the fluid conduit.

The method may include separating the effects of skin friction and local area changes.

Preferably, the method comprises:

effecting or generating a first pressure surge to propagate in the fluid conduit, the first pressure surge having a first amplitude in the fluid conduit;
measuring at least one of a pressure response or a flowrate response from the fluid conduit to provide a first pressure response or a first flowrate response data set;
effecting or generating a second pressure surge to propagate in the fluid conduit, the second pressure surge having a second amplitude in the fluid conduit; and
measuring at least one of a pressure response or a flowrate response from the fluid conduit to provide a second pressure response or a second flowrate response data set.

The method may comprise comparing the first and second data sets to determine a data set representative of the cross sectional area along the fluid conduit.

Preferably the second amplitude is different from the first amplitude.

The method may comprise repeating effecting or generating a plurality or series of pressure surges at a range of different amplitudes, and collecting at least one of a measurement of pressure or flowrate for the plurality of pressure surges.

The method may comprise estimating or determining the cross-sectional area of the fluid conduit in a first interval close to the first upstream location or region, and may comprise estimating or determining the wavespeed of the pressure surge in the fluid conduit at an area close to the first upstream location or region. The first interval may be a first section of the fluid conduit to be assessed.

The method may comprise dividing the fluid conduit into sections, and determining cross sectional area of the sections sequentially.

The method may comprise effecting or generating a pressure surge to propagate in the fluid conduit at a second time, later than the first time;

measuring at least one of a pressure response or a flowrate response from the fluid conduit to a second set of fluid conduit condition data;
comparing the second set of fluid conduit condition data with the first set of fluid conduit condition data.

According to a second aspect of the invention, there is provided a method of monitoring the condition of a fluid conduit, the method comprising:

providing a measurement apparatus comprising a measurement region in fluid communication with the fluid conduit, the measurement apparatus operable to measure at least one of pressure and flowrate in the measurement region;
effecting or generating a pressure surge to propagate in the fluid conduit at a first time;
measuring at least one of a pressure response or a flowrate response from the fluid conduit to provide a first set of fluid conduit condition data;
effecting or generating a pressure surge to propagate in the fluid conduit at a second time, later than the first time;
measuring at least one of a pressure response or a flowrate response from the fluid conduit to a second set of fluid conduit condition data;
comparing the second set of fluid conduit condition data with the first set of fluid conduit condition data.

The method may further comprise effecting or generating a pressure surge in the fluid conduit at a third and/or further time, later than the second time, to determine a third and/or further set of fluid conduit condition data; and comparing the third and/or further set of fluid conduit condition data with the second and/or first set (or other previous set) of fluid conduit condition data.

The method may comprise the step of comparing the second set of fluid conduit condition data with the first set of fluid conduit condition data to determine a change in condition of the fluid conduit. The change of condition may be a change in cross-sectional area of the fluid conduit. The times between acquisition of second and subsequent data sets may be of the order of weeks or months in the context of the monitoring applications envisaged for the present invention.

The method may comprise outputting a signal indicative of a change in condition of the fluid conduit, and may comprise providing a graphical representation of a change in the condition. Alternatively or in addition, the method may comprise providing a graphical representation of the first set of fluid conduit condition data and/or the second or subsequent sets of fluid conduit condition data.

In a preferred embodiment of the invention, the method comprises measuring a pressure response to provide a pressure data set and measuring a flowrate response to provide a flowrate data set. The measured pressure data set and the flowrate data set may then be used to determine the data set representative of the cross-sectional area along the fluid conduit.

In alternative embodiments, one of the pressure response or flowrate response is measured, with the other of the pressure or flowrate in the measurement region being a prescribed or known condition. In other words, one of the pressure data set and flowrate data set may be known a priori, and may be used together with the measured data set to determine the data set representative of the cross sectional area along the fluid conduit. However, due to practical difficulties with prescribing one of the pressure or flowrate in the measurement region with the desired accuracy, it is preferable that both the pressure response and the flowrate response are measured.

Embodiments of the second aspect of the invention may include one or more features of the first aspect of the invention or its embodiments, or vice versa.

According to a third aspect of the invention, there is provided a method of collecting pipeline condition data, the method comprising:

effecting or generating a pressure surge to propagate in a fluid conduit;
measuring a pressure response from the fluid conduit to provide a pressure data set;
measuring a flowrate response from the fluid conduit to provide a flowrate data set.

Embodiments of the third aspect of the invention may include one or more features of the first or second aspects of the invention or their embodiments, or vice versa.

According to a fourth aspect of the invention there is a method of processing pipeline condition monitoring data, the method comprising:

providing a pressure data set and a flowrate data set acquired by effecting or generating a pressure surge to propagate in a fluid conduit and measuring a pressure and flowrate responses from the fluid conduit;
determining from the pressure data set and the flowrate data set, a data set representative of the cross sectional area along the fluid conduit.

In the present invention, the area is inherently unknown and is inferred from the pressure data set and the flowrate data set. Preferably, the cross-sectional area is determined using the equation:

Q=Q₀±A·(P−P₀)/ρc

where Q and Q₀ are flowrates; A is the cross-sectional area of the fluid conduit; P and P₀ are pressures; ρ is fluid density; and c is the speed of sound in the fluid.

Embodiments of the fourth aspect of the invention may include one or more features of any of the first to third aspects of the invention or their embodiments, or vice versa.

According to a fifth aspect of the invention, there is provided a method of assessing the condition of a pipeline in an oil or gas exploration, production or transportation system, the method comprising:

effecting or generating a pressure surge to propagate in the pipeline at a first tie in point;
measuring a pressure response from the pipeline in a measurement region at or near the tie in point to provide a pressure data set;
measuring a flowrate response from in the pipeline in the measurement region to provide a flowrate data set;
determining, from the pressure data set and the flowrate data set, a condition data set representative of a cross sectional area along the pipeline downstream of the measurement region from the measured pressure and measured flowrate.

Preferably the method comprises detecting the presence and/or location of a partial restriction to the pipeline. Preferably the partial restriction is a distributed restriction on the interior of the pipeline.

Embodiments of the fifth aspect of the invention may include one or more features of any of the first to fourth aspects of the invention or their embodiments, or vice versa.

According a sixth aspect of the invention, there is provided a method of monitoring the condition of a pipeline in an oil or gas exploration, production or transportation system, the method comprising:

effecting or generating a first pressure surge to propagate in the pipeline at a first tie in point at a first time;
measuring a pressure response and a flowrate response from the pipeline in a measurement region at or near the tie in point during a first measurement interval to determine a first set of pipeline condition data;
effecting or generating a second pressure surge in the pipeline at a second time, later than the first time;
measuring a pressure response and a flowrate response from the pipeline at or near the tie in point during a second measurement interval to determine a second set of pipeline condition data;
comparing the second set of pipeline condition data with the first set of pipeline condition data.

Embodiments of the sixth aspect of the invention may include one or more features of any of the first to fifth aspects of the invention or their embodiments, or vice versa.

According to a seventh aspect of the invention there is provided a fluid conduit condition assessment apparatus comprising:

a connection for coupling the apparatus to a tie in point of a fluid conduit;
a pressure source;
a controllable actuator for generating a pressure surge in a fluid conduit in use;
a pressure sensor;
and a flowrate sensor.

Preferably the apparatus comprises a measurement region, which may be a fluid conduit portion of the measurement apparatus, and which may be continuous with the fluid conduit of which the condition is to be assessed.

The apparatus may comprise a valve operable to generate or effect the pressure surge, and the controllable actuator may be configured to operate the valve. Preferably the valve is a fast-acting valve, so that the pressure surge approximates a step change in pressure with a single wavefront.

The valve may be configured to isolate the fluid conduit from a controlled pressure source in a first (closed) condition. The controlled pressure source may comprise an accumulator. Alternatively the valve may be configured to isolate the fluid conduit from a controlled flow source in a first (closed) condition.

In one embodiment, the apparatus comprises a pressure cylinder and a piston which is actuable to deliver a controlled flowrate to the fluid conduit.

The apparatus may be configured to control one of the pressure or flowrate in the measurement region, at least during a measurement interval, to render it approximately constant before the pressure surge is effected or generated, and approximately constant after the pressure surge is effected or generated. Preferably, the one of the pressure or flowrate is held substantially constant before and after the pressure surge is generated. The apparatus may therefore be configured to suddenly generate a step change in pressure to a nominally constant value, and/or may be configured to suddenly generate a step change in flowrate to a nominally constant value. By maintaining one of the pressure or flowrate in the measurement region approximately or substantially constant, measurement inaccuracies in the method may be reduced. Slowly varying pressure or flowrate (i.e. variations to pressure or flowrate which are significantly slower than an intentional step-like change) conditions may be used in methods according to alternative embodiments of the invention.

Preferably the apparatus is configured to perform the methods of any of the first to sixth aspects of the invention, and embodiments of the seventh aspect of the invention may include one or more features of any of the first to sixth aspects of the invention or their embodiments, or vice versa.

According to an eighth aspect of the invention there is provided a pipeline condition assessment system comprising:

a fluid conduit;
an apparatus coupled to a tie in point of the fluid conduit;
a pressure source;
a controllable actuator for generating a pressure surge in the fluid conduit;
a pressure sensor;
and a flowrate sensor.

Preferably the apparatus is configured to perform the methods of any of the first to sixth aspects of the invention, and embodiments of the eighth aspect of the invention may include one or more features of any of the first to seventh aspects of the invention or their embodiments, or vice versa.

According to a ninth aspect of the invention, there is provided a method of assessing the condition of a fluid conduit, the method comprising:

providing a measurement apparatus comprising a measurement region in fluid communication with the fluid conduit, the measurement apparatus operable to measure at least one of pressure and flowrate in the measurement region;
effecting or generating a pressure surge to propagate in the fluid conduit by actuation of a valve in the measurement apparatus;
measuring at least one of a pressure response or a flowrate response from the fluid conduit;
determining, from a pressure data set and a flowrate data set, a data set representative of the cross sectional area along the fluid conduit.

Preferably the valve is a fast-acting valve, so that the pressure surge approximates a step change in pressure with a single wavefront. By generating a pressure surge using a valve in the apparatus, the uncertainties and disadvantages of using a valve which forms a part of the fluid conduit system are avoided. In particular, the valve may be selected to be fast-actuating without generating significant noise levels on opening, to maintain a sufficiently high signal to noise ratio.

Preferably the method comprises causing the flow condition in the measurement region to change from a first flow condition in which there is negligible flow of fluid in the measurement region to a second flow condition in which fluid flows in the measurement region and the fluid conduit, to thereby effect or generate a pressure surge to propagate in the fluid conduit. Thus the initial flow conditions may provide a relatively low level of background noise, and the collected data may have a good signal to noise ratio.

Embodiments of the ninth aspect of the invention may include one or more features of any of the first to eighth aspects of the invention or their embodiments, or vice versa.

According to a tenth aspect of the invention, there is provided a method of assessing the condition of a fluid conduit, the method comprising:

providing a measurement apparatus comprising a measurement region in fluid communication with the fluid conduit, the measurement apparatus operable to measure at least one of pressure and flowrate in the measurement region;
causing the flow condition in the measurement region to change from a first flow condition in which there is negligible flow of fluid in the measurement region to a second flow condition in which fluid flows in the measurement region and the fluid conduit, to thereby effect or generate a pressure surge to propagate in the fluid conduit;
measuring at least one of a pressure response or a flowrate response from the fluid conduit;
determining, from a pressure data set and a flowrate data set, a data set representative of the cross sectional area along the fluid conduit.

Preferably, the first flow condition is substantially zero or zero flow. Thus the initial flow conditions may provide a relatively low level of background noise, and the collected data may have a good signal to noise ratio.

The method may comprise effecting or generating a pressure surge to propagate in the fluid conduit by actuation of a valve in the measurement apparatus.

Embodiments of the tenth aspect of the invention may include one or more features of any of the first to ninth aspects of the invention or their embodiments, or vice versa.

The methods of the various aspects of the invention and/or the critical steps thereof are preferably implemented in software, although it will be understood that the methods or steps thereof may also be implemented in firmware or hardware or in combinations of software, firmware or hardware.

### BRIEF DESCRIPTION OF THE DRAWINGS

There will now be described, by way of example only, various embodiments of the invention with reference to the drawings, of which:

FIG. 1 is a schematic representation of a system according to an embodiment of the invention in longitudinal section;

FIGS. 2A and 2B are graphical representation of the wavepaths in an example of a method according to an embodiment of the invention, using the system of FIG. 1;

FIG. 2C is a schematic representation of a pipeline to which FIGS. 2A and 2B correspond;

FIGS. 3A and 3B graphically show modelled data for a pipeline with a restriction, in a system according to FIG. 1;

FIGS. 4A and 4B graphically show modelled data for a pipeline with a shorter restriction, in a system according to FIG. 1;

FIG. 5 shows schematically the system of FIG. 1, with the pipeline divided into intervals;

FIG. 6 is a block diagram showing schematically operational steps of a method according an embodiment of the invention;

FIG. 7 is a block diagram showing schematically a data interpretation method according to an embodiment of the invention;

FIG. 8 is a block diagram showing schematically a data interpretation method according to an embodiment of the invention;

FIG. 9 is a block diagram showing the steps of a method according to the invention that allows for the effect of friction on the propagation of the wavefront;

FIG. 10 shows schematically a system according an alternative embodiment of the invention;

FIGS. 11A and 11B graphically show modelled data for a pipeline with a restriction, in a system according to FIG. 10;

FIG. 12 shows schematically a system according a further alternative embodiment of the invention; and

FIG. 13 shows schematically a system according a further alternative embodiment of the invention.

### DETAILED DESCRIPTION OF PREFERRED EMBODIMENTS

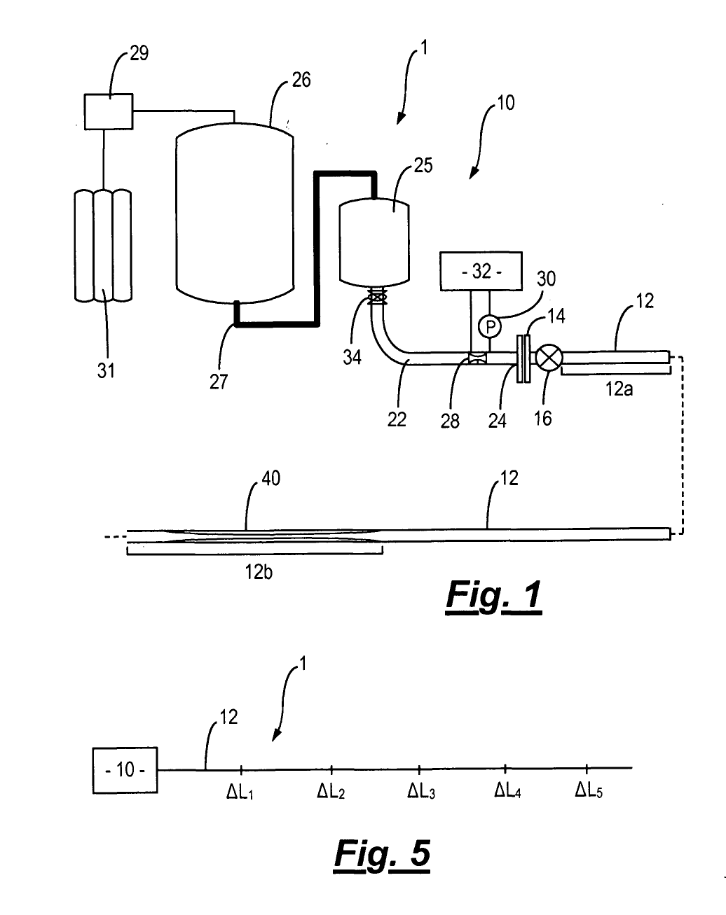

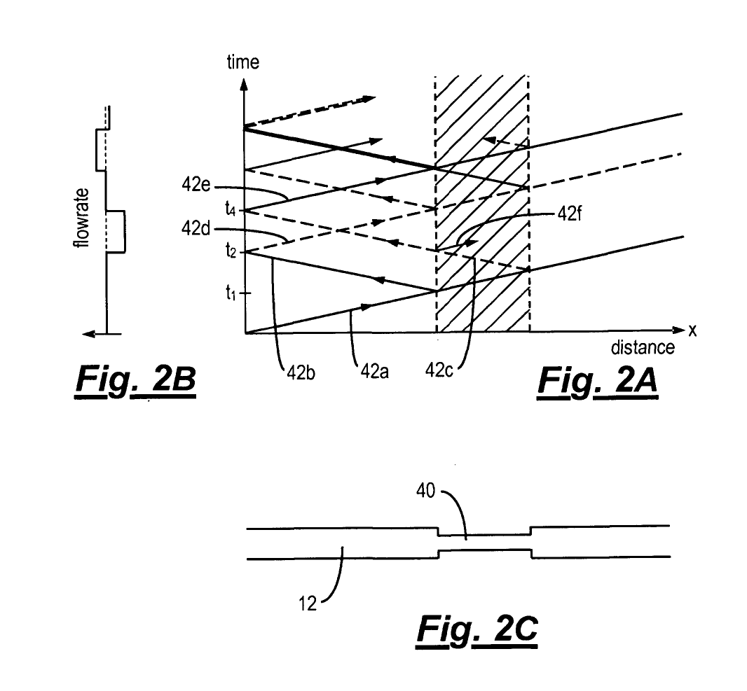

The basic principles of the invention will be described with reference to FIGS. 1, 2A, 2B and 2C. The embodiments are generally described as being implemented in a computer system and it will be appreciated that the invention may be implemented in software, hardware, firmware, or a combination thereof. Referring firstly to FIG. 1, there is shown schematically a system according an embodiment of the invention, generally depicted at 1, comprising an apparatus 10 connected to a pipeline 12. The pipeline 12 is in this example a pipeline in an oil and gas production facility, and is used for the transport of hydrocarbons. The pipeline comprises a tie-in point 14, which in this case is a flange plate, with a corresponding isolation valve 16. In the context of this description, the term “tie-in point” is used generally to refer to any suitable access point to a flowline, and is not necessarily a side-branch access point. Indeed, in preferred embodiments it is a flange plate access point at one end of a pipeline which may be conveniently accessed at a topsides/surface location.

The apparatus comprises a fluid conduit portion 22 which has an outlet 24 coupled to the pipeline 12 via the tie-in point 14. The opposing end of the conduit portion 22 is coupled to a fluid source, which in this example is a liquid vessel 25 connected to an accumulator 26 by a large diameter hose 27. The accumulator 26 is a large air accumulator controlled by a regulator 29, connected to a high pressure air source 31. The conduit portion 22 defines a measurement region for parameters of interest in the inventive method, and includes an accurate flowrate sensor or flowmeter 28, and a pressure sensor 30. Sensors 28 and 30 output measurements to a control module 32, which includes data storage and/or processing means (not shown). The conduit portion 22 also comprises a controllably actuable valve 34, also controlled by the control module 32. The valve 34 is a fast operating valve such as a hydraulically actuated pilot valve.

In use, the apparatus 10 is coupled to the pipeline 12 and the isolation valve 16 is opened. The pipeline 12 is flooded with liquid until it is full and a steady state is reached. The valve 34 is closed and the flowrate in the conduit portion 22 and pipeline 12 is zero. In this zero flowrate condition the ambient noise levels are relatively low compared with a system in which fluid is flowing in the pipeline. The pressure in the accumulator 26 is increased such that there is a pressure differential across the valve 34 of a predetermined amplitude. The valve 34 is controlled to be opened to generate a pressure surge in the conduit and pipeline 12, which propagates through the pipeline system. The valve 34 opens quickly to generate a steep-fronted pressure surge in the system. The valve 34 is designed such that its rapid opening does not generate significant levels of noise, and as such the sensors 28 and 30 are able to collect relatively clean signals. This is an important advantage over previous attempts to analyse data collected from pressure surges created by slamming shut pipeline valves.

Pressure data and flowrate data are sampled using sensors 28, 30 with high accuracy (for example at a frequency of 1 kHz or greater), as the wavefront of the pressure surge propagates in the pipeline 12. The velocity at which the wavefront propagates in the pipeline (i.e. the wavespeed) is known from theoretical calculation or measurement. In some cases, where a good estimate of the cross-sectional area of the pipeline in the region of the pipeline which is adjacent to the apparatus, the wavespeed can be estimated using the equation Q=Q₀±A·(P−P₀)/ρc; where Q and Q₀ are flowrates; A is the cross-sectional area of the fluid conduit; P and P₀ are pressures; ρ is fluid density; and c is the wavespeed. Techniques which use the transit time of a pulse propagating in the fluid conduit and reflected from a known position (such as a closed valve) in a conduit may also be used to calculate the wavespeed, and data relating to material properties or the pipeline may be used in wavespeed calculations or estimations.

In the example of FIG. 1, a first portion 12a of the pipeline is uniform and there is little change in area during the early stages of wave propagation. The pressure and flowrate measurements do not differ significantly from their initial values in the time period while the wavefront propagates in the portion 12a. In particular, the rate of flow of liquid into the pipeline will be consistent.

When the wavefront has propagated sufficiently far into the region 12b, it passes through the distributed restriction 40. The local area of flow in region 12b will be significantly smaller than that at the control end and in the first portion 12a. As a consequence of the reduction, the wavefront will behave in a manner that lies between two extreme conditions. At one extreme, the rate of flow remains constant; in this case, the velocity at the wavefront must increase and, hence, so must the pressure. At the opposite extreme, imagine that the pressure remains constant; in this case, the velocity must also be constant and so the rate of flow must have decreased. In reality, neither extreme occurs; instead, the pressure and velocity at the wavefront increase, and the flowrate decreases. The sensors 28, 30 are in the apparatus 10 at the control end of the pipe so the above behaviour will not be observed directly. However, the continuously changing conditions at the wavefront will cause continuous wave reflections that will be detected at the control sensors 28, 30.

FIGS. 2A and 2B are graphical representation of the wavepaths in an example of the method applied to pipeline 12, shown in FIG. 2C. In FIG. 2A, the x-axis represents distance along the pipeline, which has a restriction 40 along its length. At a time t₁, the wavefront 42a propagating in the pipeline meets the start of the restriction 40, and the pressure increases. This creates a reflected wavefront 42b which travels in the reverse direction towards the measurement region. At time t₃, the reflected wavefront 42b is detected at the measurement region (plotted at FIG. 2B as a decrease in flowrate). When the wavefront encounters the end of the restriction 40 at time t₂, the pressure decreases and the flowrate increases. This change generates a reflected wavefront 42c which propagates back to the measurement region. At time t₄, when the wavefront arrives at the detector, this change is measured, again shown in FIG. 2B as an increase in flowrate.

Secondary and additional changes in flowrate are detected by the apparatus at later times (from t=0 onwards). These changes are due to interaction with the restriction by secondary and additional wavefronts 42d, 42e, reflected from the end of the pipeline (at the measurement region) back towards the restriction, or wavefront 42f, resulting from a secondary interaction of reflected wavefront 42c with the restriction in the pipeline.

In this embodiment, approximately constant control pressure is prescribed, and therefore the changes to the wavefront pressure are not in fact detected by the pressure sensor 30, as the accumulator adjusts for the change in pressure by regulating the flowrate. However, the changes will be detected in the flowrate measurements: the reduction in flowrate due to the distributed restriction will be detected as a change in the flowrate measurement data; and the increase in pressure will be detected as an additional reduction in the flowrate measurement data as the accumulator 26 adjusts the flowrate to compensate for the pressure increase in the pipeline. The cumulative change in the flowrate is therefore attributable in part to a flowrate change and in part to a pressure change which result from the restriction in the pipeline. In practice, the presence of restriction can be inferred from the decrease in the measured flowrate, and its position can be estimated from the times at which the changes are detected (the speed of the wavefronts in the fluid being known).

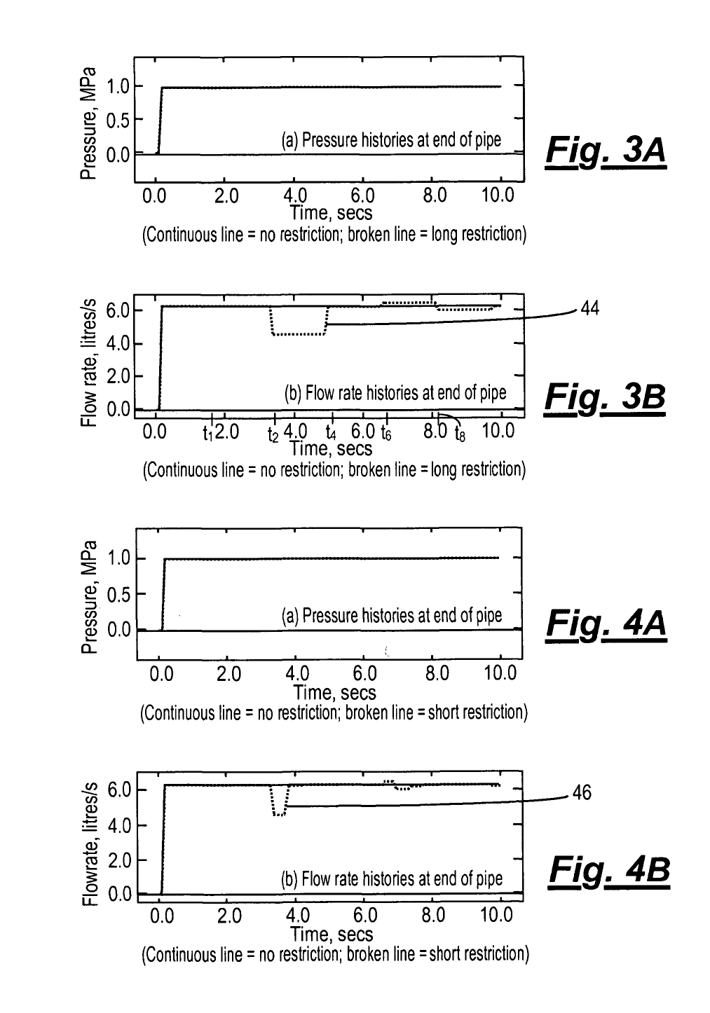

FIGS. 3A and 3B graphically show modelled data for a pipeline (not shown) having a restriction along its length, in a system as shown in FIG. 1. The model assumes that the reduced area is uniform and assumes inviscid conditions. Pressure is plotted against time in FIG. 3A, and flowrate is plotted against time in FIG. 3B. In both cases, the dotted line represents the measurement in the restricted pipeline, and the solid line represents the expected measurement in the same pipeline with no restriction.

In this example, the pressure is prescribed at the measurement region by the accumulator 26. The flow conditions are initially at a steady state, with zero flowrate into the pipeline o and constant pressure (i.e. zero change in pressure, drawn as P=0 in the drawing). Shortly after time t=0, a valve is opened to create an increase in pressure (to 1.0 MPa), which is maintained by the accumulator 26 throughout the measurement interval (shown up to 10 seconds here). The pressure increase causes a flowrate increase to approximately 6.0 litres/second, and the wavefront propagates in the pipeline. At time t₁, the wavefront meets a sudden restriction in the pipeline. At this moment, the pressure at the wavefront increases and the flowrate decreases. These changes are detected at the measurement region at time t₂, as a decrease in flowrate, with the corresponding change in pressure being compensated for by the accumulator. At a time t₄, the detectors measure an increase in flowrate, due to the wavefront encountering the end of the restriction. Again, in practice, the pressure decreases at time t₄, but this pressure change is compensated for by the accumulator and is instead seen as a corresponding change in the flowrate. At later times t₆ and t₈, changes to the flowrate are detected due to the interaction of secondary and additional wavefronts with the restriction (as described with reference to FIGS. 2A and 2B above).

FIGS. 3A and 3B illustrate that it is possible to detect the presence of a restriction in the pipeline, which is seen in this example as a reflected pulse 44 in the flowrate measurement history.

FIGS. 4A and 4B graphically show modelled data for a pipeline (not shown) having a restriction along its length. As before, the model assumes that the reduced area is uniform and assumes inviscid conditions. Pressure is plotted against time in FIG. 4A, and flowrate is plotted against time in FIG. 4B. In both cases, the dotted line represents the measurement in the restricted pipeline, and the solid line represents the expected measurement in the same pipeline with no restriction. This example is similar to the example described with reference to FIGS. 3A and 3B, although in this case, the restriction in the pipeline is considerably shorter than that of FIGS. 4A and 4B (although at the same distance along the pipeline). As can be seen from FIG. 4B, the restriction is detected as a pulse 46 in the flowrate measurement history (with pulses due to the interaction of secondary and additional wavefronts with the restriction also visible on the plot). The pulse is shorter than the pulse of FIG. 4B, as a consequence of the shorter duration between the principal reflections from the two ends of the restriction.

If further simulations were undertaken with successively shorter restrictions, the reflected pulses would become successively shorter. While this gives rise to practical limitations of the time-domain interpretation method of the invention in drawing reliable inferences about any short-duration features in the reflected signal, there are consequential benefits. For example, because of this characteristic, time-domain methods are potentially able to provide the desired information about extended regions of reduced area even if these regions include one or more local restrictions, and even when such local restrictions cause quite large reductions in area (perhaps as much as 50%). The existence of the local features will not, in itself, detract significantly from the potential of the methods of the invention to achieve the primary objective of assessing the condition of the pipeline over longer pipeline distances. For example, the method may be used to effectively deduce the cross-section of a pipeline in sections beyond the location of a valve in the pipeline.

FIG. 5 shows schematically the system 1, comprising the apparatus 10 and a pipeline 12, where the pipeline 12 has been divided into sections at ΔL₁, ΔL₂, ΔL₃, etc. In order to determine the cross-sectional area of the pipeline along its length, the inventive method uses flowrate and pressure measurement data collected at the apparatus 10. However, it will be understood that the signal attributable to a particular section, say ΔL₁<x<ΔL₂ where x is the distance along the pipeline, is deduced from reflections of wavefronts that have already been affected by the section 0<x<ΔL₁. The method may therefore comprise estimating or determining the cross-sectional area of the fluid conduit in the first section in the range 0<x<ΔL₁, and subsequently assuming that the inferred cross section data is correct. The cross-sectional area of the fluid conduit in a second section in the range ΔL₁<x<ΔL₂ downstream of the first section is then determined, and the method may be repeated for successively distant sections.

After completing the assessment of the first section, the analysis is therefore repeated (in slightly modified form) in the next section, namely ΔL₁<x<ΔL₂. Initially this step will be undertaken on the assumption that the data already inferred in the first section is correct. This is an important choice because the section 0<x<ΔL₁ will act as a telescope through which the section ΔL₁<x<ΔL₂ is viewed.

This process will then be repeated for successively more distant sections until either (a) the whole pipe has been assessed or (b) the inferred sensitivity to plausible alternative pipe profiles becomes too small for conclusions to be drawn with reasonable confidence.

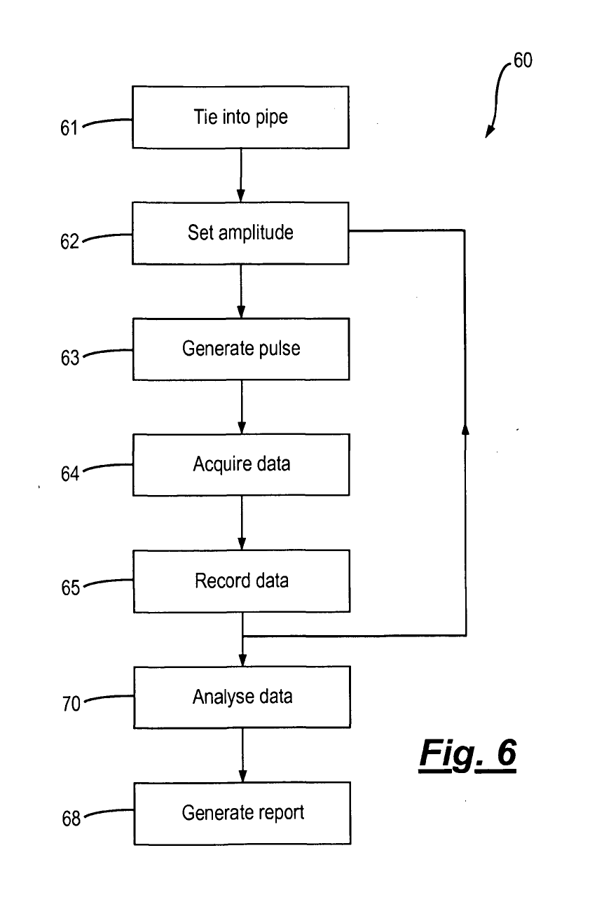

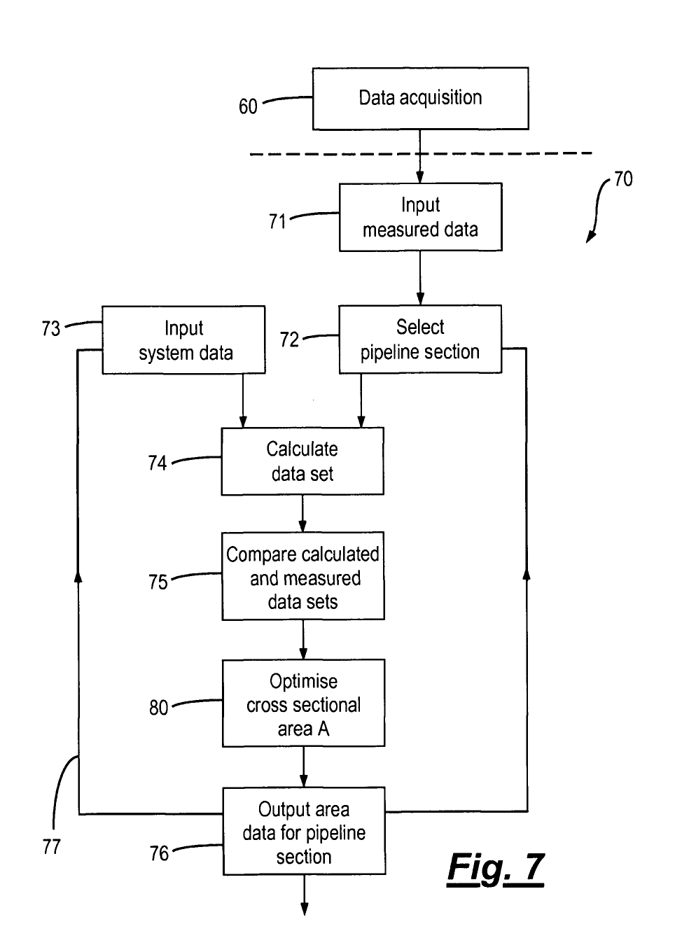

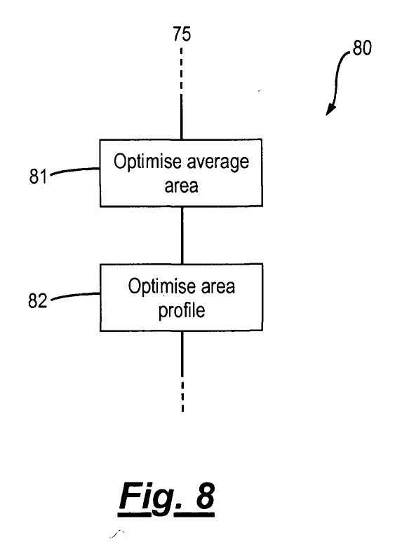

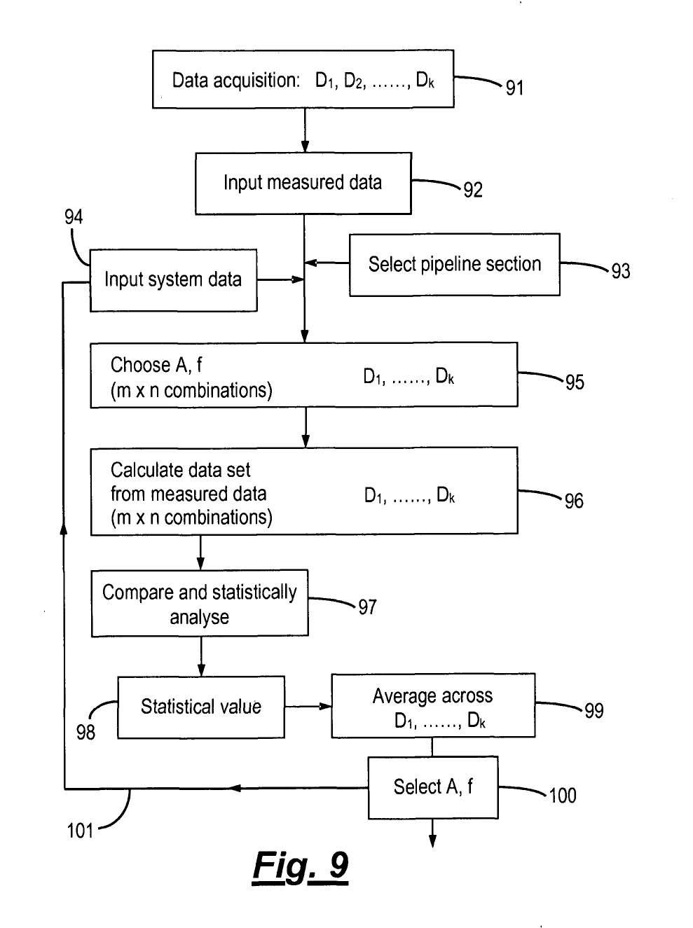

There will now be described, with reference to FIGS. 6 to 8, a method according to an embodiment of the invention which relies on the principles described above. FIG. 6 is a block diagram showing schematically operational steps of a method according to an embodiment of the invention, and FIGS. 7 and 8 are block diagrams showing schematically data interpretation methods according to embodiments of the invention.

In the method of FIG. 6, generally depicted at 60, the apparatus 10 is connected (step 61) into a pipeline system which is to be assessed. Firstly, a suitable tie-in point such as a flange plate is identified and the apparatus is connected in the manner described above with reference to FIG. 1. The apparatus 10 is configured via the control module to deliver a pressure surge to the fluid conduit at a predetermined amplitude (step 62). The amplitude is selected depending on the characteristics of the flow system; factors considered include the pipeline design; the expected propagation distance of the surge in the pipeline; the level of ambient noise, and any particular stipulations of the pipeline operator. Pressure surge amplitudes which are significantly below the strength test ratings of the pipeline are preferred, and typical surge amplitudes may be in the range of [0 psi to 100 psi (0 kPa to 690 kPa)]. Low amplitude surges, for example in the range of 0 to 10 psi (0 kPa to 69 kPa) are preferred because they are not significantly influenced (e.g. attenuated) by friction effects, and in some embodiments pressure surges in the range of 0 to 2 psi (0 kPa to 13.8 kPa) may be preferred. However, a suitable balance will need to be struck between reducing the effects of friction and generating a response which is detectable by the sensors in a practical pipeline system. Typically, a user of the apparatus will be provided with a specified pressure surge amplitude or a range of pressure surge amplitudes according to a pre-designed test procedure, and these will be entered into the control module interface.

When the test procedure is ready to begin, the isolation valve 16 is opened and the pipeline 12 is flooded with liquid until it is full and a steady state is reached. At this point, the flow into the pipeline is negligible and is preferably nil. The pressure in the accumulator is regulated to provide a pressure differential across the valve 34 according to the surge amplitude predetermined for the test procedure. The valve 34 is then rapidly opened to create a pressure surge which propagates in the apparatus conduit 22 and pipeline 12 (step 63). The valve 34 is preferably a fast acting hydraulic valve, as it is desirable for the pressure surge to be as close as possible to a square step change in pressures (as shown in FIG. 3A). However, in practice, a perfect step change in pressure will not be achieved, and there will be some “rounding” or “spreading” of the wavefront.

The sensors 28, 30 rapidly sample flowrate and pressure data respectively (step 64), and time series of flowrate and pressure data are recorded by the apparatus (step 65). Typical sampling rates for the flowrate and/or pressure are of the order of tens of Hz, and preferably greater than 100 Hz. It is desirable for sample rates to exceed 1 kHz to provide improved data resolution, particularly in shorter pipeline measurement lengths and/or pipeline systems with higher wave speeds. The data acquisition begins prior to the generation of the surge, so that the time series includes the detection of the wavefront as it passes through the apparatus conduit 22. Data are recorded to digital memory in the apparatus for subsequent analysis. The data may be retrieved by removing digital storage from the apparatus, or by interfacing the apparatus with computer processing equipment or an external storage device. It will also be appreciated that in alternative embodiments, a processing module may be incorporated in apparatus to carry out some or all of the required analysis or interpretation.

The time series flowrate and pressure data is recorded over a measurement interval which enables all useful information relating to the propagation of the wavefront in the fluid conduit to be collected. In practice the useful data measurement interval may finish before the time taken for the wavefront to reach (and be reflected from) a major blockage or complete restriction (such as a fluid conduit termination or closed valve) in the fluid conduit. After this point, the acquired data is dominated by the complete reflection of the pressure surge by the blockage or complete restriction, and little or no useful information about the condition of the pipeline along the length of the pipeline can be derived.

Optionally, the test procedure is repeated at the same pressure amplitude (for example, to provide data redundancy and improved signal to noise ratio) or at a different pressure surge amplitude (the advantages of which will be described later with reference to FIG. 8).

When all the relevant data has been collected, it is analysed (step 70) to deduce information about the cross sectional area of the pipeline along its length. The analysis and interpretation of data are described in greater detail with reference to FIGS. 6 and 7. A report generated for the pipeline operator (step 68) may include average cross-sectional areas of the pipeline in different regions of the pipeline; general indications of the locations of distributed restrictions such as deposits or build ups in the interior of the pipeline; calculations of the amount of debris or wax in a region of the pipeline; approximate locations of where a restriction in the pipeline begins or ends. This data can be used by the operator to monitor changes to the pipeline condition, or to design a pipeline remediation programme which may for example involve flushing or pigging the pipeline, or the replacement of pipeline sections.

FIG. 7 shows schematically various steps of a data analysis or interpretation method 70 according to an embodiment of the invention. Data is acquired, for example according to the method 60 of FIG. 6 steps 61 to 65. Subsequently, the data is analysed according to the steps 71 to 77 of FIG. 7. It will be appreciated that data interpretation may be carried out within the apparatus 10, and may indeed be carried out in situ at the test site. However, the data analysis 70 may equally be carried out at a different location and/or a later time, and may be performed using any suitable computer software and/or hardware tools.

This embodiment of the invention utilises pressure surge analysis software which is widely used in industry and academic research to model the flow regimes in a range of flow systems. Examples of commercially-available software packages include software available from Flight Software N.I. Limited under the trade mark FluidFlow3; the pressure surge analysis software available from Flowmaster Group and designated by the commercial name FLOWMASTER; the flow assurance and surge analysis software available from Simulation Software Limited and sold under the trade mark VARISIM; and the water hammer analysis software available from KYPipe LLC sold under the product designation SURGE. These software packages (and others) enable a pipeline system to be designed and boundary conditions related to flowrates and pressures to be configured by the user. The software then models the flow regime enabling flowrates and pressures in the modelled pipeline system to be simulated according to the boundary conditions input by the user.

As a first step, data acquired from a previous test procedure is input into the software (step 71). The user also inputs pipeline system data to the software to model the flow system (step 73). The data is input according to the features of the system which are known, which may be approximate topologies and/or pipeline components. In the context of the invention, the true cross-sectional area of the pipeline is unknown, and is the parameter to be deduced, although a reasonable starting value for the analysis may be derived from the original pipeline system design data.

As noted above, to simplify the analysis, cross-sectional areas of sections of the pipeline will be deduced sequentially, section-by-section, starting from a first section closest to the measurement apparatus and working away from the measurement apparatus. The cross-sectional areas attributed to each section will be used to deduce the areas of sequential sections. Therefore as a further preliminary step it is necessary to divide the pipeline into a number of sections (step 72). This may be performed by any of a range of techniques. One automated technique is to calculate the average flowrate over two halves of a pipeline interval extending from a starting point x₀ in the pipeline to a distance x₁. The distance x₁ is extended until the average flowrates in the first and second halves differ by more than a predetermined threshold (say 10%). This indicates a change in pipeline conditions over the length to x₁ which is significant enough to take the pipeline section x₀ to x₁ as the first section for analysis. Other simple techniques include identifying significant changes in the approximate gradient of flowrate with respect to distance along the pipeline, and/or selecting sections in which the gradient is reasonably constant.

With the first pipeline section selected, a starting value for cross-sectional area A is chosen (step 73). The software package is used to calculate, based on its input parameters (including the starting value for A) and the measured pressure data time series, a simulated flowrate data time series (step 74). This simulated flowrate data time series is then compared with the measured flowrate data time series (step 75). Discrepancies between the simulated and measured data indicate one or more inaccuracies or false assumptions in the starting data and/or errors in the measurement signal. The method therefore applies statistical techniques to fit the simulated data to the measured data by optimising the cross-sectional area value A (step 80). This is achieved by making an adjustment to the cross-sectional area value A in the pipeline section being assessed, and then recalculating the simulated data set based on the new value for A. The new simulated data set is compared to the measured data and the process is repeated until the simulated data set is matched to the measured data set to an acceptable degree. The value of A used in the matched simulated data set is taken to be the cross-sectional area for the pipeline in the section analysed.

FIG. 8 is a block diagram showing the optimisation steps of a method 80 according to an embodiment of the invention. In this approach, the cross-sectional area A is optimised in two distinct stages. During the first stage 81, the area A is assumed to be uniform over the length of the pipeline section under analysis. Adjustments are made to the value of A and the simulated data set is recalculated to provide the best match with the measured data (assuming a uniform area over the section). When the value of A is optimised on this basis for the section, a second stage of optimisation 82 is carried out. In this second stage 82, the value of A is assumed to be the average (mean) value of the cross-sectional area over the section. However, the profile of the cross-sectional area is no longer assumed to be uniform, and the value of A may be varied over the length of the pipeline section. In a simple example, a gradient may be applied to the cross-sectional area over the length of the section, such that the value of A at one end of the section is lower than the value at the opposite end, while maintaining the average value of A over the section. In other words, the cross-sectional area is assumed to vary or taper linearly with respect to distance over the pipeline section. In an alternative example, the inner diameter of the pipeline section is assumed to vary linearly with respect to distance over the section.

In either case, the profile of the cross-sectional area is optimised to provide the best fit for the simulated data with the measured data to deduce cross-sectional area information in the pipeline section.

A variety of statistical analysis techniques may be used within the scope of the invention, as would be appreciated by one skilled in the art. Least-squares analysis methods are one example, but equally other techniques may be used. The statistical method will include appropriate allowance for residual noise in the measured signals. This may include the time-averaging of signals to create smoothing and it may include the specification of tolerances with which differences between measured and trial-predictions will be compared.

Returning now to FIG. 7, for the assessment of the next section of the pipeline, the software takes the previously calculated value (or profile) of cross-sectional area output (step 76) from the method as a fixed input parameter (used in 73) in the pipeline system data and the method is repeated (step 77) for the next section.

A pressure wave moving along a pipe is approximately equal the sum of the speed of sound and the fluid speed, U. Thus, relative to the pipe, waves travelling downstream propagate at c+U and waves travelling upstream move slightly more slowly at c−U. The propagating waves are influenced by (a) inertia, (b) variations in area and (c) friction, all of which are experienced simultaneously, and can be described by the following equations:

$$\frac{d p}{d t} = - ρ c \frac{d U}{d t} - \frac{ρ {Uc}^{2}}{a} \frac{\partial a}{\partial x} - c {τ}_{w} \frac{𝓁}{a}$$

(satisfying a wave travelling downstream); and

$$\frac{d p}{d t} = ρ c \frac{d U}{d t} - \frac{ρ {Uc}^{2}}{a} \frac{\partial a}{\partial x} + c {τ}_{w} \frac{𝓁}{a}$$

(satisfying a wave travelling upstream).

In both equations: a is cross-sectional area; c is speed of sound; l is the cross-sectional perimeter; p is pressure; r is the time co-ordinate; U is fluid velocity; x is the distance co-ordinate; ρ is fluid density; and τ_{w} is shear stress at the pipe wall surface. The three terms on the right-hand side of the equations are measures of the influences of (i) inertia, (ii) variations in area and (iii) friction respectively.

It is intended that the testing will be undertaken with pressure surges that do not cause the measurements to be strongly influenced by friction. Accordingly, the simplified method described above ignores the effect of friction for the purposes of determining the cross-sectional area. However, this might not always be possible. When it is not, the accuracy with which the pipeline geometry can be inferred will depend upon the extent to which the influences of friction and area change can be separated. This will be described below with reference to FIG. 9, which is a block diagram showing the steps of a method 90 according to the invention that includes steps for dealing with unknown frictional effects on the propagation of waves in the pipeline.

In the method 90, data is acquired during a test procedure, for example according to the method 60 of FIG. 6 steps 61 to 65, for a first pressure surge amplitude, with the resulting data set D₁ stored or exported for later analysis. Second and further data sets D₂ to Dₖ are acquired by repeating the test procedure at different pressure surge amplitudes, and the data sets D₁ to Dₖ are input into pressure surge analysis software (step 92).

As with the method of FIG. 7, to simplify the analysis cross-sectional areas of sections of the pipeline will be deduced sequentially. Therefore as a preliminary step it is necessary to divide the pipeline into a number of sections (step 93).

The user also inputs pipeline system data to the software to model the flow system (step 94). As before, the data is input according to the features of the system which are known, which may be approximate topologies and/or pipeline components. Also as before, the true cross-sectional of the pipeline is unknown, and is the parameter to be deduced, although a reasonable starting value for the analysis may be assumed from the original pipeline system design data. A series of m values of A are chosen for the system input data, and a series of n values of f, representing the frictional interaction between the fluid and the pipe (step 95). The series of A and f each include a range of values which has both smaller and larger values than the most likely values of A and f. The system data input into the system are of course dependent on the pressure surge amplitude, and therefore the software is required to model m×n combinations of area and friction parameters for each pressure surge value used for the pipeline section under analysis.

The pressure surge analysis software is used to calculate (step 96), based on its input parameters (including m×n combinations of the starting values for A and f) and the measured pressure data time series, a simulated flowrate data time series. This is performed for each data set in turn, so that k×m×n simulated flowrate time series are calculated.

The simulated flowrate data time series are then compared (step 97) with the measured flowrate data time series. Discrepancies between the simulated and measured data indicate one or more false assumptions in the starting data (i.e. the choice of A and f) or measured data, and statistical techniques (for example, the mean square difference) are used to derive a statistical value (step 98) and rank the m×n combinations of A and f. An average of the statistical values for each combination of A and f is calculated (i.e. averaged across all k data sets corresponding to pressure surge values) to give an m×n average values (step 99). The m×n average values are then reviewed to select the one that implies the closest match to the measured flowrate time series (step 100). The values of A and f in that gives this selected average value is deemed to be the correct combination of A and f for the pipeline section under analysis.

For the assessment of the next section of the pipeline, the software takes the previously deduced values of A and f as fixed input parameters in the pipeline system data and the method is repeated for the next section (step 101).

The method described with reference to FIG. 9 uses multiple data sets, acquired from tests with different pressure surge amplitudes, to separate the effects of the frictional interaction between the fluid and the pipeline on the wavefront from the effects of changes in area. It will be appreciated that the above-described method is illustrative only, and a number of other approaches may be used within the scope of the invention. In particular, there are many possible ways of making the necessary comparisons between the simulated data sets and the measured data; statistical descriptions of the difference between each predicted history and its measured equivalent can be undertaken in many ways. For example, positive and negative differences between the simulated and measured data sets could be treated differently. In addition, automatic search processes such as genetic algorithms could be used in alternative implementations of the invention.

The above-described embodiments relate to a methodology in which the pressure in the measurement region (or at the tie-in point of the fluid conduit) is the prescribed condition, and is kept approximately constant in the measurement interval. However, it is also within the scope of the invention to perform a similar method in which the flowrate in the measurement region (or at the tie-in point of the fluid conduit) is the prescribed condition, and is kept approximately constant. It is also within the scope of the invention to perform a similar method in which one of the pressure or flowrate is slowly varying or changing (i.e. variations to pressure or flowrate are significantly slower than intentional step-like changes).

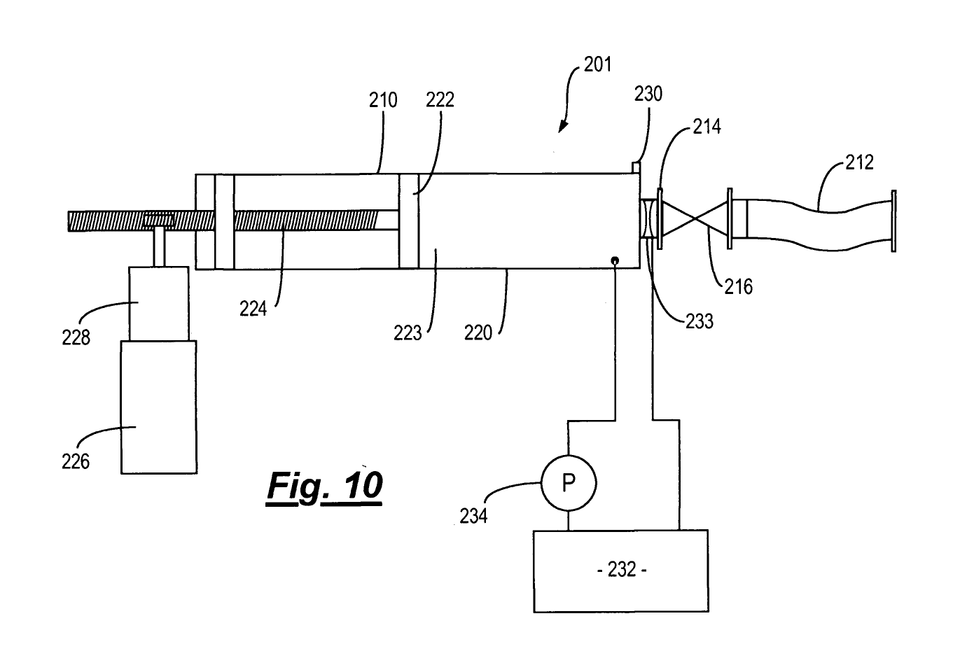

FIG. 10 shows schematically a system according an embodiment of the invention, generally depicted at 201, comprising an apparatus 210 connected to a pipeline 212. The system 201 is similar to the system 1 of the first embodiment of the invention, although it is designed to maintain flowrate as an approximately constant or slowly varying condition (rather than pressure). The pipeline 212 is in this example a pipeline in an oil and gas production facility, and is used for the transport of hydrocarbons. The pipeline comprises a tie-in point 214, which in this case is a flange plate, with a corresponding isolation valve 216.

The apparatus 210 comprises a pressure cylinder 220 which accommodates a piston 222. The internal volume 223 of the pressure cylinder 220 is in fluid communication with the pipeline, and comprises an inlet 230 to enable the inflow of fluid from a fluid source (not shown). The piston is connected to an actuator 224, which is a threaded rod driven by an electric motor 226 via a mechanical gearbox 228, such that rotation of the electric motor 226 causes the piston to be extended or retracted in the cylinder to reduce or increase the internal volume 223. The gearbox 228 is configured to drive the piston into the cylinder at a preset rate which would not vary during operation. An electric motor is preferred as it rotates at a constant speed, drawing more or less current as the torque load increases, whereas a hydraulically actuated system may vary the rate of progression of the piston as the pressure changes. The apparatus 210 also comprises a control module 232 which controls the electric motor 226, flowmeter 233 and pressure sensor 234 in the measurement region defined by the cylinder during a measurement interval.

In use, the cylinder 220 is filled with a liquid via the inlet 230 with the piston fully retracted to the start position to maximise the volume 223. The isolation valve 216 is opened and the pressure in the cylinder is equalised with the pressure in the pipeline such that conditions are stable. The electric motor drives the piston into the cylinder to displace fluid from the apparatus and into the pipeline at a constant flowrate for a single stroke. The apparatus therefore generates a pressure surge in the pipeline 212. Flowrate and pressure data are measured by flowmeter 233 and pressure sensor 234 in the measurement region. The data acquisition begins prior to the generation of the surge, so that the time series includes the detection of the wavefront as it passes through the measurement region. Data are recorded to digital memory in the apparatus for subsequent analysis.

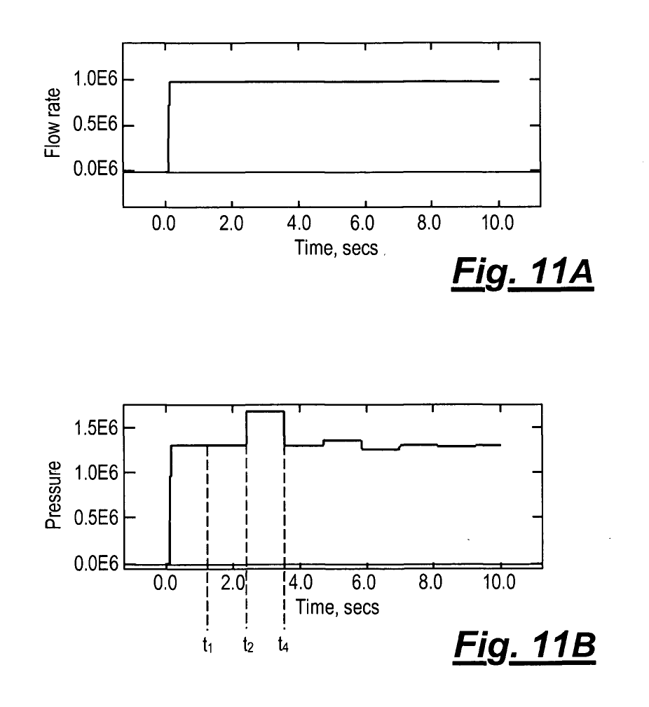

FIGS. 11A and 11B graphically show modelled data for the pipeline 212 having a restriction (not shown) along its length, in a system as shown in FIG. 10. In this illustration, the model assumes that the reduced area is uniform and assumes inviscid conditions. Flowrate is plotted against time in FIG. 11A, and pressure is plotted against time in FIG. 11B.

The data is analogous to the example described with reference to FIGS. 3A and 3B, although in this case, the condition prescribed at the measurement region is the flowrate. The flow conditions are initially at a steady state, with a flowrate into the pipeline of zero and zero pressure. Shortly after time t=0, valve 216 is opened to create an increase in flowrate, which is maintained by the movement of the piston 222 throughout the measurement interval (shown up to 10 seconds here). The flowrate increase has a corresponding pressure increase, and the wavefront propagates in the pipeline. At time t₁, the wavefront meets a sudden restriction in the pipeline. At this moment, the pressure at the wavefront increases and the flowrate decreases. These changes are detected at the measurement region at time t₂, as an increase in pressure, with the corresponding change in flowrate being compensated for by the accumulator. At a time t₄, the detectors measure a drop in pressure, due to the wavefront encountering the end of the restriction. Again, in practice, the flowrate decreases at time t₄, but this pressure change is compensated for by the piston and is instead seen as a corresponding change in the pressure. The cumulative change in the pressure is therefore attributable in equal part to a pressure change and a flowrate change which result from the restriction in the pipeline. In practice, the presence of the restriction can be inferred from a continuous decrease in the measured pressure, and its position can be estimated from the times at which the changes are detected (the speed of the wavefronts in the fluid being known).

Thus according to the method described above, pressure and flowrate histories can be derived from a system in which the flowrate is kept approximately constant or slowly varying at one end of the pipeline system. Such an approach may not be preferred in all practical implementations due to the difficulties in achieving a sharply defined incident wavefront (or step-form pressure surge). However, there are also advantages to such an approach, including those associated with the ease of rapid pressure sampling (compared with the flowrate sampling relied upon in the previous embodiments). Data acquired in this way may be analysed according to the embodiments described with reference to FIGS. 6 to 9. It will be apparent that the pressure surge in the method of FIGS. 10 and 11 is generated during a single stroke of the piston, and it must therefore be sized appropriately for the creation of a pressure surge of sufficient duration. In one embodiment of the invention, the data acquisition method is performed multiple times with different gear ratios, to create pressure surges of different amplitudes. Multiple datasets at different pressure amplitudes may be used in to distinguish the effects of friction from those due to changes in cross-sectional area, for example in the manner described with reference to FIG. 9 above.

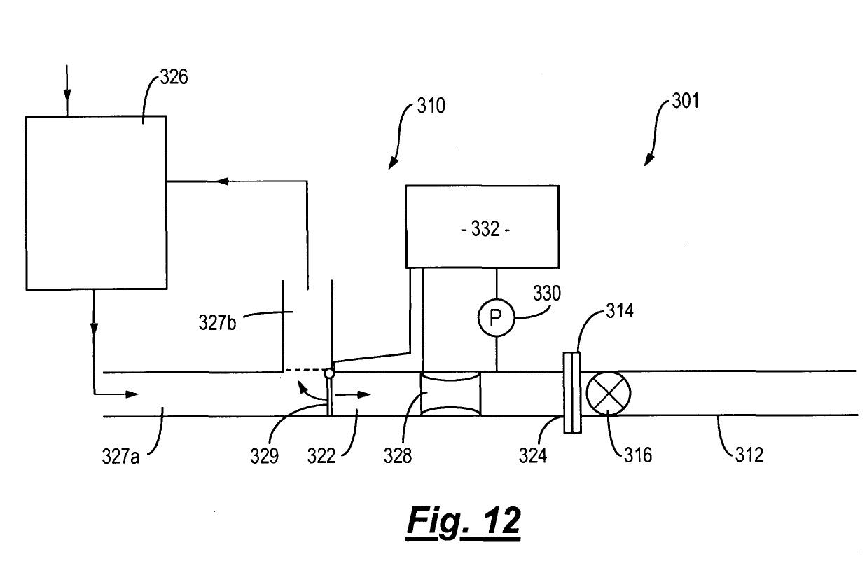

FIG. 12 shows schematically a system according an alternative embodiment of the invention, generally depicted at 301, in which the flowrate in the measurement region (or at the tie-in point of the fluid conduit) is the prescribed condition, and is kept approximately constant or slowly varying. The system 301 comprises an apparatus 310 connected to a pipeline 312. The system 301 is similar to the system 201, in that it is designed to maintain flowrate as an approximately constant or slowly varying condition. The pipeline 312 is a pipeline in an oil and gas production facility, and is used for the transport of hydrocarbons. The pipeline comprises a tie-in point 314, which in this case is a flange plate, with a corresponding isolation valve 316. Other like parts are indicated by like reference numerals incremented by 100.

The apparatus 310 differs from the apparatus 210 in that it does not include a pressure cylinder 220 accommodating a piston. Instead, the apparatus 310 has a fluid or slowly varying source 326 which in a first condition, delivers fluid at a controlled and substantially constant or slowly varying flowrate to an inlet conduit portion 327a of the apparatus. A valve 329, which in the example shown is a flapper valve, isolates the inlet conduit portion 327a from the fluid conduit portion 322, and fluid flows into an outlet 327b (in this case a return line is shown to the fluid source 326 although other configurations are possible).

In use, fluid flows at a controlled flowrate in the flow path defined by the inlet conduit portion 327a and the outlet 327b. The isolation valve 316 is opened and the pressure in the cylinder is equalised with the pressure in the pipeline such that conditions are stable. The valve 329 is actuated to move to a position, shown by the dotted line 331, in which it diverts flow from the inlet conduit portion 327a to the conduit portion 322. The apparatus therefore generates a pressure surge in the pipeline 312. Flowrate and pressure data are measured by flowmeter 333 and pressure sensor 334 in the measurement region. The data acquisition begins prior to the generation of the surge, so that the time series includes the detection of the wavefront as it passes through the measurement region. Data are recorded to digital memory in the apparatus for subsequent analysis.

The system 301 has the advantage that the flowrate in the measurement region can be changed from zero to a non-zero flow condition quickly by actuation of the valve, and may therefore produce a well-defined pressure surge in the pipeline, which is useful for detecting gradual changes in the pipeline condition along its length.

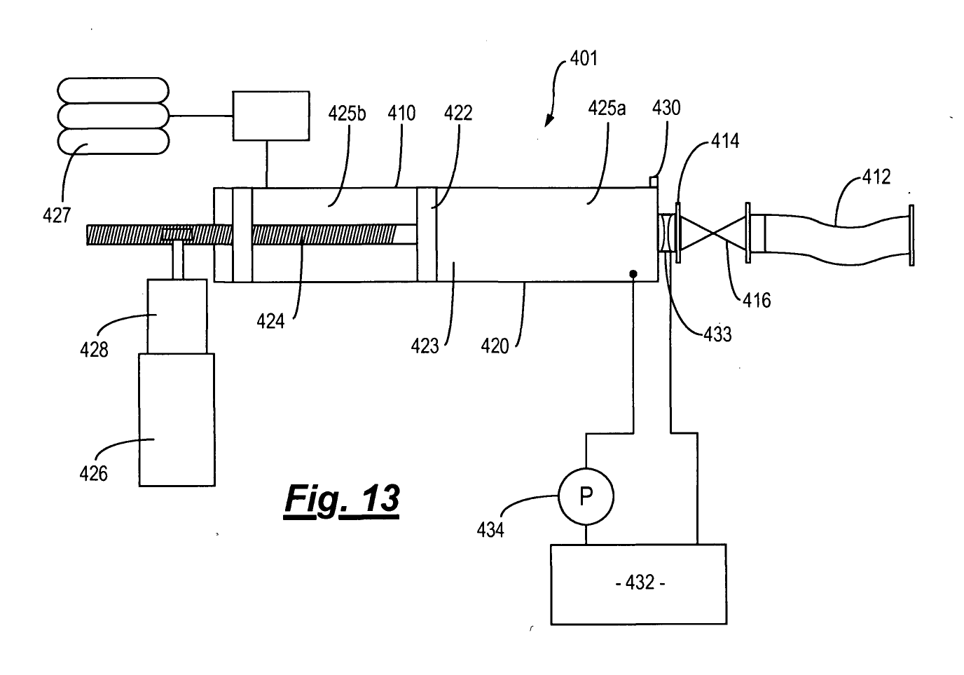

A further alternative embodiment of the invention is shown schematically with reference to FIG. 13 of the drawings. In FIG. 13, the system generally depicted at 401 is similar to the system 201 of a previous embodiment of the invention, being designed to maintain flowrate as an approximately constant or slowly varying condition (as opposed to pressure), and will be understood from FIG. 10 and the accompanying drawings. Like features are indicated by like reference numerals incremented by 200. The pipeline 412 is in this example a pipeline in an oil and gas production facility, and comprises a tie-in point 414, which in this case is a flange plate, with a corresponding isolation valve 416.

The apparatus 410 comprises a pressure cylinder 420 in fluid communication with the pipeline, and comprises an inlet 430 to enable the inflow of fluid from a fluid source (not shown). The piston is connected to an actuator 424, which causes the piston to be extended or retracted in the cylinder to reduce or increase the internal volume 423. The apparatus 410 also comprises a control module 432 which controls the electric motor 426, flowmeter 433 and pressure sensor 434 in the measurement region defined by the cylinder during a measurement interval.

In use, the cylinder 420 is filled with a liquid via the inlet 430 with the piston fully retracted to the start position to maximise the volume 423. The isolation valve 416 is opened and the pressure in the volume of the cylinder 425a on the forward side of the piston 422 is equalised with the pressure in the pipeline such that conditions are stable. In this embodiment the pipeline 412 contained pressurised fluid, at (for example) 4,000 psi (about 27.6 MPa). The volume of the cylinder 425b on the reverse side of the piston 422 is fluidly connected to a pressure source such as a bank of accumulators 427 to balance the pressure across the piston (i.e. in this example to maintain it at 4,000 psi or about 27.6 MPa).

The electric motor drives the piston into the cylinder to displace fluid from the apparatus and into the pipeline at a constant flowrate for a single stroke. The apparatus therefore generates a pressure surge in the pipeline 412, over and above the baseline pressure of 4,000 psi. Flowrate and pressure data are measured by flowmeter 433 and pressure sensor 434 in the measurement region. The data acquisition begins prior to the generation of the surge, so that the time series includes the detection of the wavefront as it passes through the measurement region. Data are recorded to digital memory in the apparatus for subsequent analysis in accordance with the methods described above.

An advantage of the system of FIG. 13 and the associated method is that the application of pressure surges to a pressurised pipe system reduces the impact of gases in the pipeline 412. A compressible gas phase in the pipeline would complicate the analysis of the acquired data, and is therefore undesirable. By performing the method on a pressurised pipeline system a gas phase which may otherwise be present in the pipeline at lower (e.g. ambient pressure) may be forced into its liquid phase and/or mixed or dissolved with the liquid contained in the pipeline 412. The approach taken in this embodiment may therefore reduce or avoid a requirement to flush the pipeline system with a liquid (for example by a gel-pigging process) which is time-consuming and expensive.

It will be appreciated that the above-described embodiments of the invention may be varied within the scope of the invention. In particular, it will be apparent to one skilled in the art that the method is potentially well-suited to use as the basis of automatic assessment algorithms enabling area profiles to be inferred from the measured signals without detailed human intervention.

According to the invention, there is described a method of and apparatus for assessing the condition of a fluid conduit. The method comprises providing a measurement apparatus comprising a measurement region in fluid communication with the fluid conduit. The measurement apparatus is operable to measure at least one of pressure and flowrate in the measurement region. A pressure surge is effected or generated to propagate in the fluid conduit, and at least one of a pressure response or a flowrate response from the fluid conduit is measured. From a pressure data set and a flowrate data set, a data set representative of the cross sectional area along the fluid conduit is determined. This enables average or overall area profiles along long fluid pipelines to be deduced.

The theoretical basis of the method is a relatively simple application of the pressure surge analysis, and a preferred embodiment utilises pressure and flow measurements at one end of a pipeline during the introduction of a disturbance just upstream of the measurement location. The embodiments are generally described as being implemented in a computer system and it will be appreciated that the invention may be implemented in software, hardware, firmware, or a combination thereof.

It is an advantage of the method that interpretation is based in the time domain that dominates everyday life, not in the frequency domain (in contrast with many prior art methods of assessing measured signals that include rapid changes). Time-domain analysis is well suited to the deduction of overall area profiles even though frequency-domain analysis is usually necessary for detecting and locating local phenomena such as leaks and restrictions.

The method is able to infer cross-sectional areas close to the measurement locations with good accuracy. Allowance can be made for skin friction even though its effects can be closely analogous to those of area variation.

The invention provides measurements with a good signal to noise ratio, which enables small and gradual changes in the pipeline condition to be detected. In particular, the invention enables the use of small flowrates which enable data interpretation to distinguish between noise and intended changes to the flow system.

The method is relatively insensitive to short lengths of restricted area, which enables the technique to be used to infer pipeline information beyond restrictions such a partially closed valve.

Various modifications may be made within the scope of the invention as herein intended, and embodiments of the invention may include combinations of features other than those expressly claimed.

### REFERENCES

#1. Arbon, N S, Stephens, M, Lambert, M F, Simpson, A R, Lucas, B, Milsom, G & Braendler, J (2008) “Field validation of transient analysis for in-line valve condition assessment”, Proc 10^{th} int conf on Pressure surges, Edinburgh, UK, 14-16 May 2008, BHR Group, Ed: S. Hunt, 169-179.
#2. Duan, H-D, Lee, P J, Ghidaoui, M S & Tung, Y-K (2011) “Leak detection in complex series pipelines by using the system frequency response method”, Journal of Hydraulic Research, 49(2), 213-221.
#3. Gudmundsson, J S (Inventor) (1996) “Method for determination of flowrate in a fluid”, International patent publication number WO 96/15427.
#4. Gudmundsson, J S (Inventor) (2002) “Method for determining pressure profiles in wellbores, flowlines and pipelines, and use of such method”, International patent publication number WO 02/25062.
#5. Kapelan, Z S, Savic, D A & Walters, G A (2003) “A hybrid inverse transient model for leakage detection and roughness calibration in pipe networks”, Journal of Hydraulic Research, 41(5), 481-492.
#6. Lee, P J, Vitkovsq, J P, Lambert, M F, Simpson, A R & Liggett, J A (2008) “Discrete blockage detection in pipelines using the frequency response diagram: numerical study”, Journal of Hydraulic Engineering, ASCE, 134(5), 658-663
#7. Shamlooa, H & Haghighi, A (2009) “Leak detection in pipelines by inverse backward transient analysis”, Journal of Hydraulic Research, 47(3), 311-318.
#8. Taghvaei, M, BVeck, S B M, Boxall, J B, Seth, A & Staszewski, W J (2008) “Leak and feature detection in a water distribution network”, Proc 10^{th} int conf on Pressure surges, Edinburgh, UK, 14-16 May 2008, BHR Group, Ed: S. Hunt, 125-135.

1. A method of assessing the condition of a fluid conduit in an oil or gas exploration, production or transportation system, the method comprising:
providing a measurement apparatus comprising a fluid conduit portion, the fluid conduit portion defining a measurement region in fluid communication with the fluid conduit to be assessed, and wherein the measurement apparatus is operable to measure pressure and flowrate in the measurement region;
using the measurement apparatus to effect or generate a step change in pressure, flow rate, or fluid velocity to cause a wavefront to propagate away from the measurement region and to a section of the fluid conduit to be assessed;
measuring in the measurement region a pressure response from the fluid conduit to provide a pressure data set;
measuring in the measurement region a flowrate response from the fluid conduit to provide a flowrate data set;
determining, from the pressure data set and the flowrate data set, a condition data set representative of a cross-sectional area along the fluid conduit in the section of the fluid conduit to be assessed.

2. The method as claimed in claim 1 wherein the condition data set is representative of average cross-sectional area of the fluid conduit in the section of the fluid conduit.

3. The method as claimed in claim 1 wherein one of the pressure or the flowrate in the measurement region is controlled, at least during a measurement interval, to render it approximately constant or slowly varying before the step change is effected or generated, and/or approximately constant or slowly varying after the step change is effected or generated.

4. The method as claimed in claim 3 wherein the one of the pressure or flowrate is held substantially constant before and after the step change is generated.

5. The method as claimed in claim 1 comprising opening a valve to generate the step change in the fluid conduit.

6. The method as claimed in claim 5 wherein the valve forms a part of the measurement apparatus.

7. The method as claimed in claim 1 comprising causing a flow condition in the measurement region to change from a first flow condition in which there is negligible flow of fluid in the measurement region to a second flow condition in which fluid flows in the measurement region and the fluid conduit, to thereby effect or generate the step change and cause the wavefront to propagate in the fluid conduit.

8. The method as claimed in claim 1 comprising:
effecting or generating the step change in the fluid conduit at a first upstream location or region;
measuring the pressure response from the fluid conduit;
measuring the flowrate response from the fluid conduit;
determining, from a pressure data set and a flowrate data set, a data set representative of the cross-sectional area along the fluid conduit downstream from the first upstream location or region.

9. The method as claimed in claim 1 comprising sampling the pressure response and/or flowrate response over a measurement interval, which begins before the step of effecting or generating the step change.

10. The method as claimed in claim 1 comprising interpreting the measured data in the time domain.

11. The method as claimed in claim 1 comprising flooding the fluid conduit with a liquid.

12. The method as claimed in claim 1 comprising analysing one or more data sets to separate the effects of skin friction and local area changes.

13. The method as claimed in claim 1 comprising:
effecting or generating a first step change to cause a first wavefront to propagate in the fluid conduit, the first wavefront having a first amplitude in the fluid conduit;
measuring a pressure response and a flowrate response from the fluid conduit to provide a first pressure response data set and a first flowrate response data set;
effecting or generating a second step change to cause a second wavefront to propagate in the fluid conduit, the second wavefront having a second amplitude in the fluid conduit; and
measuring a pressure response and a flowrate response from the fluid conduit to provide a second pressure response data set and a second flowrate response data set.

14. The method as claimed in claim 13 comprising comparing the first and second data sets to determine the condition data set representative of the cross-sectional area along the fluid conduit.

15. The method as claimed in claim 13 wherein the second amplitude is different from the first amplitude.

16. The method as claimed in claim 13 comprising repeating effecting or generating a plurality or series of step changes to cause a plurality or series of wavefronts at a range of different amplitudes, and collecting at least one of a measurement of pressure or flowrate for the plurality of wavefronts.

17. The method as claimed in claim 1 comprising dividing the fluid conduit into sections, and determining cross sectional area data of the sections sequentially.

18. The method as claimed in claim 1 comprising:
effecting or generating a second step change to cause a second wavefront to propagate in the fluid conduit at a second time, later than the first time;
measuring at least one of a pressure response or a flowrate response from the fluid conduit to a second set of fluid conduit condition data;
comparing the second set of fluid conduit condition data with the first set of fluid conduit condition data.

19. A method of monitoring the condition of a fluid conduit in an oil or gas exploration, production or transportation system, the method comprising:
providing a measurement apparatus comprising a fluid conduit portion, the fluid conduit portion defining a measurement region in fluid communication with the fluid conduit to be assessed, and wherein the measurement apparatus is operable to measure at least one of pressure and flowrate in the measurement region;
using the measurement apparatus to effect or generate a step change in pressure, flow rate, or fluid velocity to cause a wavefront to propagate away from the measurement region and to a section of the fluid conduit to be assessed at a first time;
measuring in the measurement region at least one of a pressure response or a flowrate response from the fluid conduit to provide a first set of fluid conduit condition data;
using the measurement apparatus to effect or generate a step change in pressure, flow rate, or fluid velocity to cause a wavefront to propagate away from the measurement region and to a section of the fluid conduit to be assessed at a second time, later than the first time;
measuring in the measurement region at least one of a pressure response or a flowrate response from the fluid conduit to a second set of fluid conduit condition data;
comparing the second set of fluid conduit condition data with the first set of fluid conduit condition data.

20. The method as claimed in claim 19 comprising effecting or generating a third step change in the fluid conduit at a third and/or further time, later than the second time, to determine a third and/or further set of fluid conduit condition data; and comparing the third and/or further set of fluid conduit condition data with the second and/or first set of fluid conduit condition data.

21. The method as claimed in claim 19 comprising comparing the second set of fluid conduit condition data with the first set of fluid conduit condition data to determine a change in condition of the fluid conduit.

22. The method as claimed in claim 21 wherein the change of condition is a change in cross-sectional area of the fluid conduit.

23. The method as claimed in claim 19 comprising outputting a signal indicative of the change in condition of the fluid conduit.

24. The method as claimed in claim 19 comprising providing a graphical representation of the change in condition.

25. The method as claimed in claim 19 comprising providing a graphical representation of the first set of fluid conduit condition data and/or the second set of fluid conduit condition data.

26. The method as claimed in claim 19 comprising measuring a pressure response to provide a pressure data set and measuring a flowrate response to provide a flowrate data set.

27. A method of assessing the condition of a pipeline in an oil or gas exploration, production or transportation system, the method comprising:
effecting or generating a step change in pressure, flow rate, or fluid velocity to cause a wavefront to propagate in the pipeline at a first tie in point;
measuring a pressure response from the pipeline in a measurement region at or near the tie in point to provide a pressure data set;
measuring a flowrate response from in the pipeline in the measurement region to provide a flowrate data set;
determining, from the pressure data set and the flowrate data set, a condition data set representative of a cross sectional area along the pipeline away from the measurement region from the measured pressure and measured flowrate.

28. The method as claimed in claim 27 comprising detecting the presence and/or location of a partial restriction to the pipeline.

29. The method as claimed in claim 28 wherein the partial restriction is a distributed restriction on the interior of the pipeline.

30. A method of monitoring the condition of a pipeline in an oil or gas exploration, production or transportation system, the method comprising:
effecting or generating a first step change in pressure, flow rate, or fluid velocity to cause a wavefront to propagate in the pipeline at a first tie in point at a first time;
measuring a pressure response and a flowrate response from the pipeline in a measurement region at or near the tie in point during a first measurement interval to determine a first set of pipeline condition data;
effecting or generating a second step change in pressure, flow rate, or fluid velocity to cause a wavefront to propagate in the pipeline at a second time, later than the first time;
measuring a pressure response and a flowrate response from the pipeline at or near the tie in point during a second measurement interval to determine a second set of pipeline condition data;
comparing the second set of pipeline condition data with the first set of pipeline condition data.

31. A fluid conduit condition assessment apparatus comprising:
a fluid conduit portion defining a measurement region of the apparatus;
a connection for coupling the fluid conduit portion to a tie in point of a fluid conduit in an oil or gas exploration, production or transportation system to be assessed;
a pressure source;
a controllable actuator for generating a step change in pressure, flow rate, or fluid velocity to cause a wavefront to propagate in the fluid conduit away from the measurement region in use;
a pressure sensor;
and a flowrate sensor.

32. The apparatus as claimed in claim 31 comprising a measurement region in a fluid conduit portion of the measurement apparatus continuous with the fluid conduit of which the condition is to be assessed.

33. The apparatus as claimed in claim 31 comprising a valve operable to generate or effect the step change, and the controllable actuator is configured to operate the valve.

34. The apparatus as claimed in claim 33 wherein the valve is configured to isolate the fluid conduit from a controlled pressure source in a first (closed) condition.

35. The apparatus as claimed in claim 33 wherein the valve is configured to isolate the fluid conduit from a controlled flow source in a first (closed) condition.

36. The apparatus as claimed in claim 31 configured to control one of the pressure or flowrate in the measurement region, at least during a measurement interval, to render it approximately constant or slowly varying before the step change is effected or generated, and/or approximately constant or slowly varying after the step change is effected or generated.

37. An oil or gas exploration, production or transportation pipeline condition assessment system comprising:
an apparatus according to claim 31 coupled to a tie in point of the fluid conduit.
